(19) United States
(12) Patent Application Publication
(10) Pub. No.: US 2017/0106797 A1
(43) Pub. Date: Apr. 20, 2017

(54) ELCTRONIC MIRROR DEVICE AND NON-TRANSITORY COMPUTER-READABLE RECORDING MEDIUM

(71) Applicant: Panasonic Intellectual Property Management Co., Ltd., Osaka (JP)

(72) Inventors: TAKASHI OKOHIRA, Kanagawa (JP); JUN NAKAI, Kanagawa (JP)

(21) Appl. No.: 15/390,224

(22) Filed: Dec. 23, 2016

Related U.S. Application Data
(63) Continuation of application No. PCT/JP2015/003278, filed on Jun. 30, 2015.

(30) Foreign Application Priority Data
Jul. 2, 2014 (JP) 2014-136527

(51) Int. Cl. B60R 1/00; G06K 9/00; B60K 35/00; B60R 11/02; B60R 11/04

(52) U.S. Cl. CPC B60R 1/00; B60R 11/0235; B60R 11/04; B60K 35/00; G06K 9/00805; B60R 2011/0033

(57) ABSTRACT

The electronic mirror device has a display unit and a control unit. The display unit, which is disposed on the mounting position of the rearview mirror in the vehicle interior of the own vehicle, displays an image of an area behind the own vehicle captured by a camera. The control unit displays the image captured by the camera on the display unit. Further, upon detection of an approach of the subsequent vehicle based on the images captured by the camera, the control unit lights up an outer periphery region of the display unit.

### BACKGROUND

1. Technical Field

The present disclosure relates to an electronic mirror device capable of detecting a subsequent vehicle rapidly approaching to an own vehicle and giving a warning to the subsequent vehicle.

2. Background Art

Conventionally, as a device that detects a rapid approach of a subsequent vehicle and gives a warning to the subsequent vehicle, there is a known example in which a periphery monitoring system mounted on the rear section of the own vehicle measures the distance between the own vehicle and the subsequent vehicle and gives a warning about rear-end collision by lighting up the brakelight (for example, see Japanese Translation of PCT Publication No. 2009-519162).

### SUMMARY

The present disclosure provides an electronic mirror device capable of giving a warning about a rapid approach made by a subsequent vehicle, without needing for a specific device that measures, for example, the distance from the subsequent vehicle. The warning, unlike the case of warning by lighting up the brakelight, is given to a limited small number of drivers including the driver of the subsequent vehicle. That is, the electronic mirror device detects a rapid approach made by the subsequent vehicle and gives a warning to the subsequent vehicle.

The electronic mirror device of the present disclosure has a display unit and a control unit. The display unit, which is disposed on the mounting position of the rearview mirror in the interior of the own vehicle, displays an image of an area behind the vehicle captured by a camera. The control unit displays the image captured by the camera on the display unit. According to the image captured by the camera, the control unit lights up an outer periphery region of the display unit upon detection of an approach of a subsequent vehicle.

The aforementioned subsequent vehicle means the vehicle coming immediately after the own vehicle on the same driving lane.

According to the present disclosure, the electronic mirror device detects a rapid approach of the subsequent vehicle based on an image captured by a camera mounted in advance on the vehicle that employs the electronic mirror device. Therefore, there is no need for a dedicated device for detecting the approach of the subsequent vehicle.

Further, the electronic mirror device of the present disclosure gives a warning by lighting up an outer periphery region of the display unit. The warning, compared to the case of warning by lighting up the brakelight, is given to a limited smaller number of drivers including the driver of the subsequent vehicle.

### BRIEF DESCRIPTION OF DRAWINGS

FIG. 1 is a front view of the interior of the vehicle where the electronic mirror device of the present disclosure is mounted.

FIG. 2 is a plan view of the vehicle shown in FIG. 1.

FIG. 3 is a perspective view of the structure seen from the side of the vehicle shown in FIG. 2.

FIG. 4 is a front view of the display unit of the electronic mirror device in accordance with an exemplary embodiment of the present disclosure.

FIG. 5 is a control block diagram of the electronic mirror device in accordance with the exemplary embodiment of the present disclosure.

FIG. 6 is an example showing correspondence between an approaching subsequent vehicle and a display image of the vehicle in accordance with the exemplary embodiment of the present disclosure.

FIG. 7 shows an example of warning criteria employed by the electronic mirror device in accordance with the exemplary embodiment of the present disclosure.

FIG. 8 is a flowchart showing an example of operation of the electronic mirror device in accordance with the exemplary embodiment of the present disclosure.

FIG. 9 is an example showing transition of display image of the display unit shown in FIG. 4.

### DETAILED DESCRIPTION

### Exemplary Embodiment

Prior to description of the exemplary embodiment of the present disclosure, problems in a conventional warning device will be described briefly.

A conventional warning device that detects a rapid approach of a subsequent vehicle and gives a warning to the vehicle needs a dedicated device for measuring inter-vehicle distance, such as a periphery monitoring system. Besides, the warning by lighting up the brakelight is recognized not only by the driver of the subsequent vehicle but also by the drivers of other vehicles, i.e., it draws the attention of many drivers.

In recent years, an electronic mirror device has been becoming popular. Mounted on the position of the rearview mirror, the electronic mirror device shows the driver an image captured by a camera mounted on the vehicle, giving a drive assist.

Commonly, the luminance level of the display unit of an electronic mirror device is higher than that of an ordinary rearview mirror. In particular, at nighttime, the light from the electronic mirror device of a preceding vehicle is often recognized by the driver of the subsequent vehicle.

According to the exemplary embodiment, the display unit of the electronic mirror device is used for a device that gives a warning to the subsequent vehicle, by which an abnormal approach of the subsequent vehicle can be detected without needing an additional device. Besides, the camera of the electronic mirror device is used as a device for detecting a subsequent vehicle. Therefore, the warning is recognized by the driver of the subsequent vehicle and a limited small number of drivers.

Hereinafter, an example in which the electronic mirror device of the exemplary embodiment is mounted on a vehicle will be described with reference to the drawings.

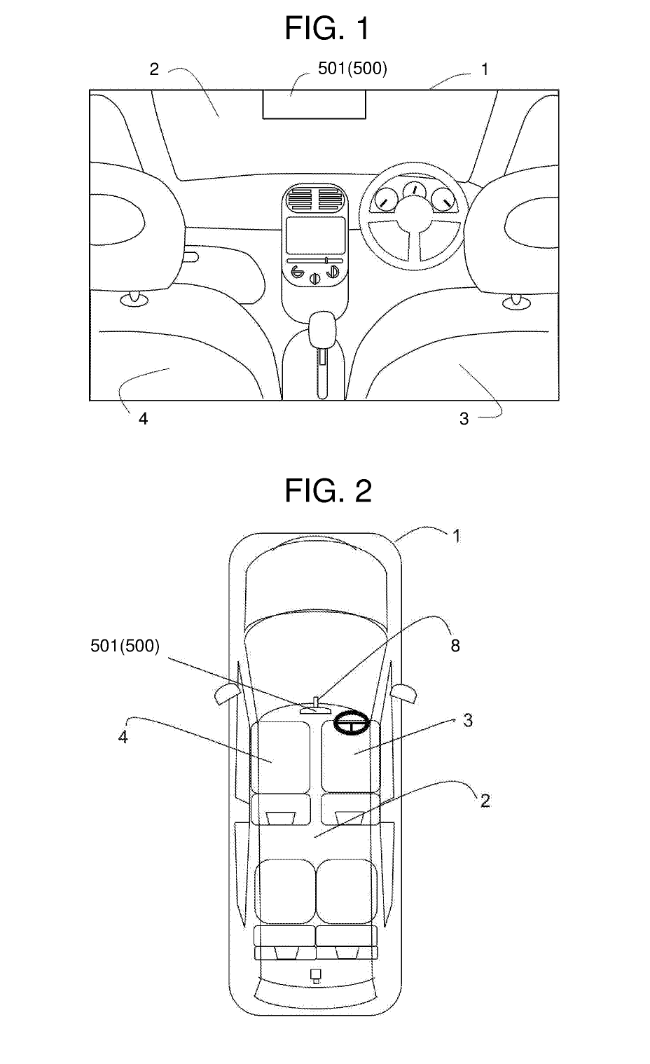

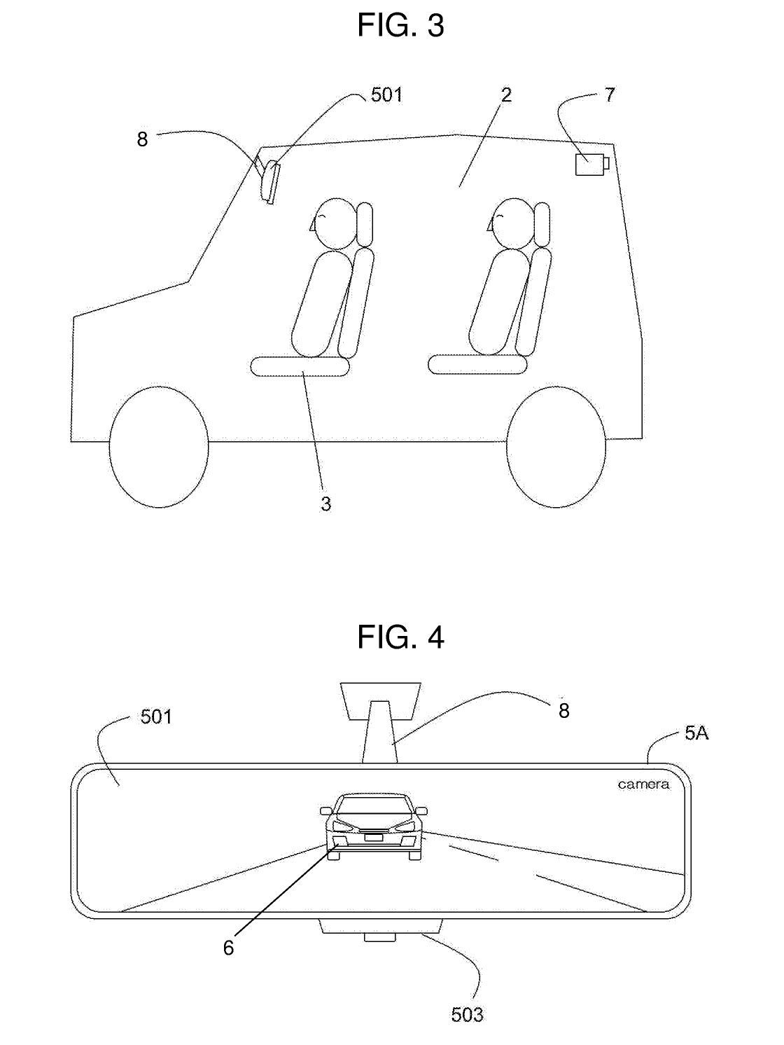

FIG. 1 is a front view of vehicle interior 2 where electronic mirror device 500 of the embodiment of the present disclosure is mounted. FIG. 2 is a plan view of vehicle 1. FIG. 3 is a perspective view of the structure seen from the side of vehicle 1. FIG. 4 is a front view of display unit 501 of electronic mirror device 500.

As shown in FIG. 1 through FIG. 3, in a front section between driver seat 3 and passenger seat 4 in vehicle interior 2 of vehicle (own vehicle) 1, display unit 501 forming electronic mirror device 500 is attached to the position of the rearview mirror so as to be movable on fixing member 8.

Display unit 501 is formed of, for example, liquid crystal display. As shown in FIG. 4, it is accommodated in case 5A that opens toward the driver seat so that the surface of liquid crystal display faces the driver seat. During running of vehicle 1, display unit 501 displays subsequent vehicle 6, for example.

A half mirror (not shown) is disposed in front of the surface of liquid crystal display of display unit 501. Driver's operation on operation unit 503 allows display image of display unit 501 to be switched between display by the liquid crystal display and display by the half mirror.

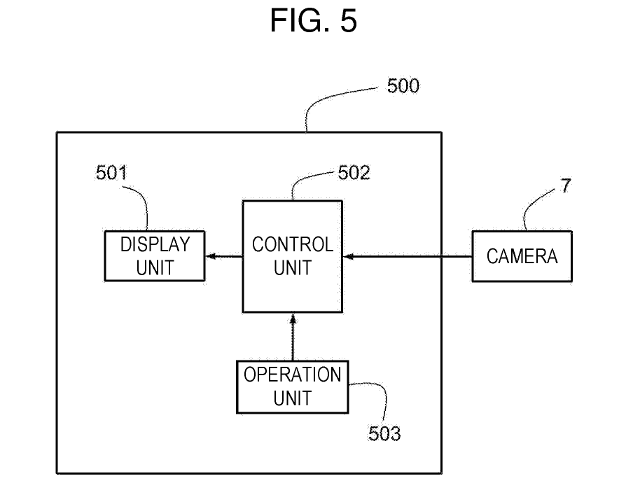

FIG. 5 is a control block diagram of electronic mirror device 500. Display unit 501 is connected to control unit 502 that controls display unit 501. Control unit 502 is connected to camera 7 and operation unit 503. Control unit 502 has a CPU (Central Processing Unit) that is an operation controller, ROM (Read Only Memory) for storing control programs, and RAM (Random Access Memory) for storing temporary data and control data. Display unit 501, control unit 502, and operation unit 503 form electronic mirror device 500.

Control unit 502 displays an image captured by camera 7 on display unit 501. Upon detection of an approach of subsequent vehicle 6, based on the image captured by camera 7, control unit 502 lights up the outer periphery region of display unit 501.

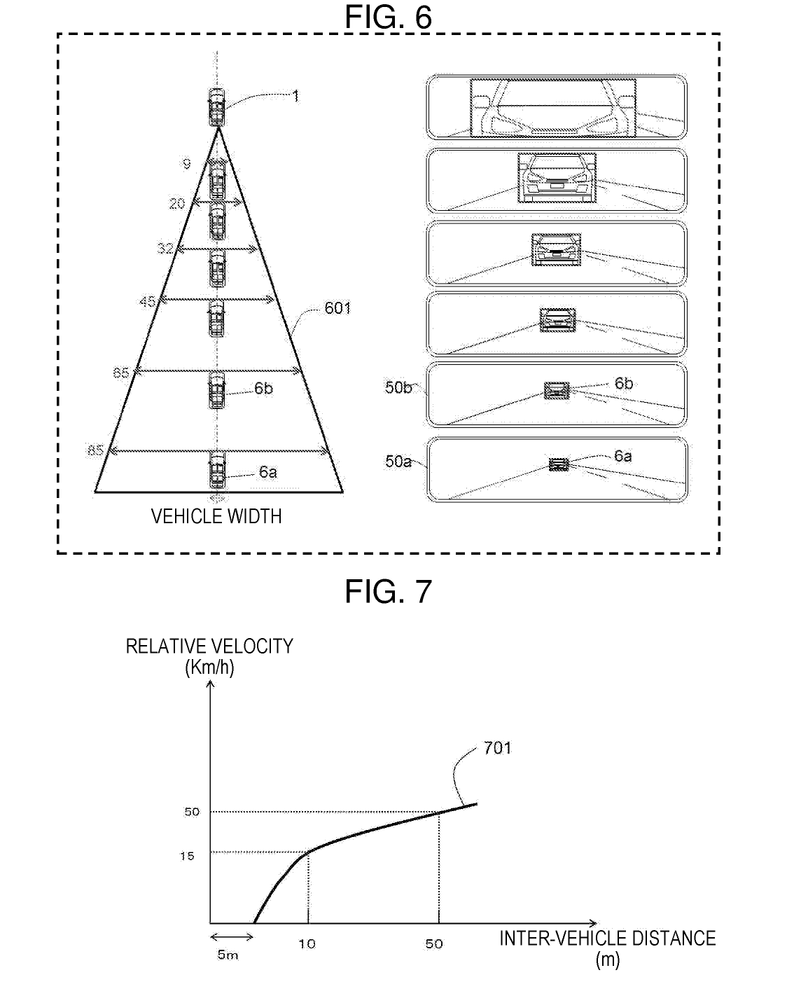

Hereinafter, the operation of electronic mirror device 500 will be described with reference to FIG. 6 through FIG. 9.

FIG. 6 is an example showing correspondence between subsequent vehicle 6 approaching to own vehicle 1 and a display image on display unit 501.

The corresponding data between the distance from own vehicle 1 to subsequent vehicle 6 and the vehicle width in the display image of subsequent vehicle 6 within the distance, which is formed into a graph or a function, is stored in RAM of control unit 502.

Control unit 502 retains the corresponding data in which the width of subsequent vehicle 6 is defined to 6 mm, for example, as the ordinary vehicle width. That is, FIG. 6 shows a display example of unit 501 in which subsequent vehicle 6 having a vehicle width of 6 mm in field angle 601 of camera 7 has changes in display image as it comes closer to own vehicle 1.

Control unit 502 detects subsequent vehicle 6a in display image 50a and calculates the vehicle width of subsequent vehicle 6a in display image 50a. Based on the calculated vehicle width, control unit 502 determines the distance between subsequent vehicle 6a and own vehicle 1 with reference to the graph or the function. Control unit 502 calculates the vehicle width of subsequent vehicle 6b in display image 50b that is captured, for example, 100 milliseconds after the captured time of display image 50a so as to determine the distance between own vehicle 1 and subsequent vehicle 6b.

In FIG. 6, each of the double-headed arrows in the field angle and each of the numerical values shown aside of respective arrow show a width in each field angle 601, i.e., correspond to a length shown by the width of the display unit.

Control unit 502 calculates relative velocity of own vehicle 1 and subsequent vehicle 6 in display image 50b, based on the following data: the distance between own vehicle 1 and subsequent vehicle 6a obtained from display image 50a; the distance between own vehicle 1 and subsequent vehicle 6b obtained from display image 50b; and difference in captured time between display image 50a and display image 50b. That is, control unit 502 calculates, based on the time-series images captured by the camera, the distance between own vehicle 1 and subsequent vehicle 6 and the relative velocity.

Control unit 502 compares the calculated relative velocity with the warning criteria. FIG. 7 is an example of the warning criteria stored in RAM of control unit 502. The horizontal axis represents the distance between own vehicle 1 and the subsequent vehicle, and the vertical axis represents relative velocity.

FIG. 7 shows a relationship between the distance from own vehicle 1 to subsequent vehicle 6 and the relative velocity, having warning criteria 701 determined on the assumption that subsequent vehicle 6 stops safely 2 meters behind the own vehicle. FIG. 7 shows that a relative velocity not more than warning criteria 701 has no risk of rear-end collision and no need for warning, whereas a relative velocity exceeding warning criteria 701 has a risk of rear-end collision and therefore warning is needed.

Control unit 502 compares the relative velocity in display image 50b with the warning criteria. That is, it determines whether the relative velocity with respect to the distance between own vehicle 1 and subsequent vehicle 6 is lower than the warning criteria or not.

If the relative velocity exceeds the warning criteria, control unit 502 displays a warning on display unit 501. Control unit 502 gives a warning by lighting up the outer periphery region in red so that display unit 501 has red-edged periphery region. At the time, control unit 502 scales down the display image that the display unit usually shows so as to fit in the area inner than the outer periphery region. By virtue of the scaled down display, the electronic mirror device, even during the warning is being displayed, consistently works as it is intended.

Control unit 502 similarly processes other time-series images at intervals of, for example, 100 milliseconds.

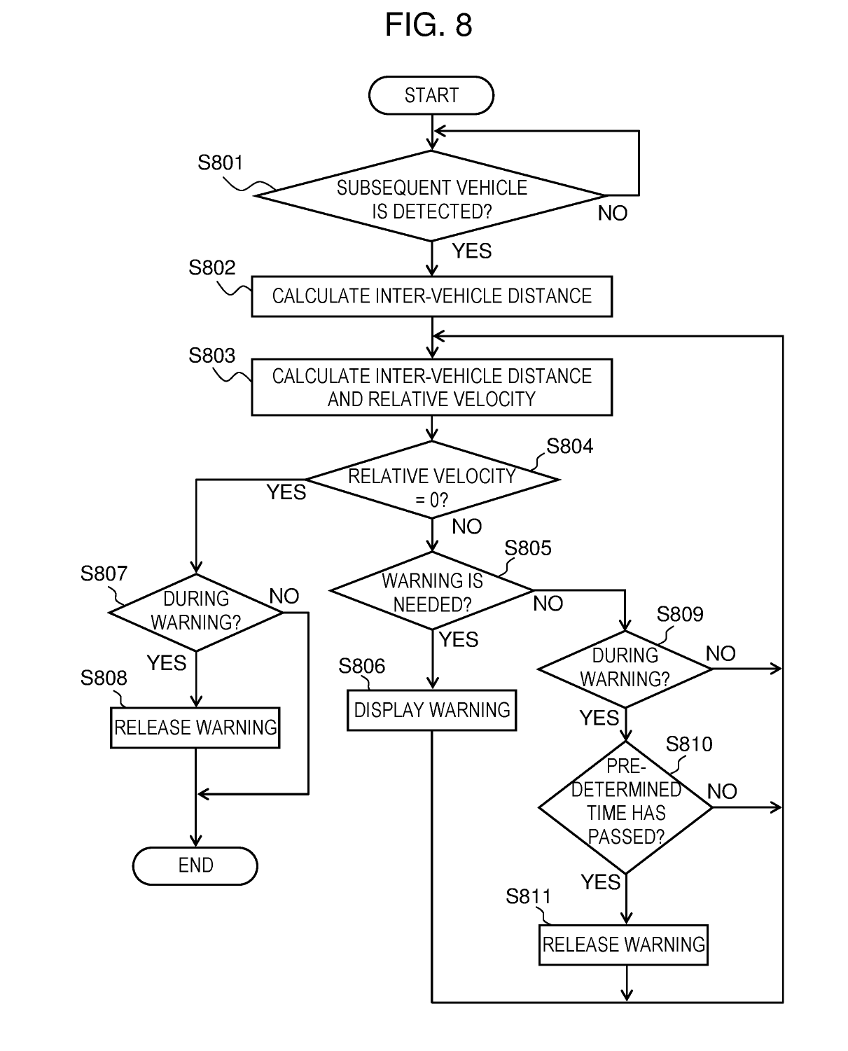

FIG. 8 is a flowchart showing an example of main operation of electronic mirror device 500 of the exemplary embodiment.

Upon the start of the warning routine, control unit 502 begins detection of a subsequent vehicle from the image captured by the camera (in step S801). Control unit 502 repeats the process until it finds any subsequent vehicle (i.e., corresponding to ‘NO’ in step S801). If control unit 502 detects a subsequent vehicle (i.e., corresponding to ‘YES’ in step S801), it calculates, based on the vehicle width of the subsequent vehicle, the distance between own vehicle 1 and the subsequent vehicle (in step S802). Control unit 502 calculates the vehicle width of the subsequent vehicle from the image captured 100 milliseconds after the previous image and determines the distance between the two vehicles and the relative velocity (in step S803). If the relative velocity is equivalent to zero (i.e., corresponding to ‘YES’ in step S804), which corresponds to the state where the subsequent vehicle makes a stop when the own vehicle is in the stop state, control unit 502 further determines whether during giving warning or not. If it is during giving warning (i.e., corresponding to ‘YES’ in step S807), control unit 502 releases the warning display and switches it into the normal display (in step S808), the procedure goes to end. If it is not during giving warning (i.e., corresponding to ‘NO’ in step S807), the procedure goes to end.

If the relative velocity is not zero (i.e., corresponding to ‘NO’ in step S804), control unit 502 compares the relative velocity with respect to the distance between the two vehicles with the warning criteria. If the warning is needed (i.e., corresponding to ‘YES’ in step S805), control unit 502 lights up the outer periphery region of display unit 501 in red; and at the same time, it scales down the camera image so as to fit into the area inner than the red-edged outer periphery region, and displays the scaled-down image (in step S806).

If the warning is not needed (i.e., corresponding to ‘NO’ in step S805), and further, if it is not during giving warning (i.e., corresponding to ‘NO’ in step S809), the procedure goes back to step 5803. If it is during giving warning (i.e., corresponding to ‘YES’ in step S809), control unit 502 determines whether a lapse of time since the determination of no need of warning is greater than a predetermined value (for example, 3 seconds) or not (in step S810). If the lapse of time is greater than the predetermined value (i.e., corresponding to ‘YES’ in step S810), control unit 502 releases the warning display and switches it into the normal display (in step S811), and the procedure goes back to step 5803.

If the lapse of time is smaller than the predetermined value (i.e., corresponding to ‘NO’ in step S810), the procedure goes back to step 5803, without releasing the warning display.

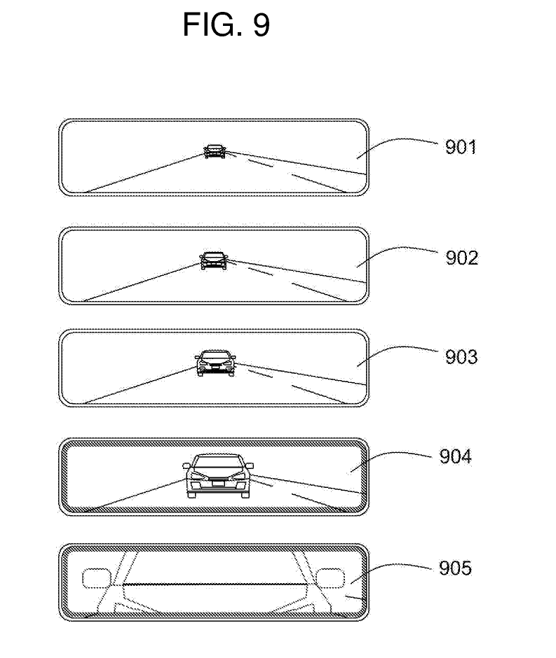

FIG. 9 is an example showing transition of display image of display unit 501 of the exemplary embodiment. Display images 901 through 903 are in the normal state, while display images 904 and 905 are in the warning state. The outer periphery region of display images 904 and 905 is lit up, i.e., the outer periphery region of display unit 501 is edged with red. The image that is shown in full screen of display unit 501 in the normal state is scaled down in the warning state so as to fit into the area inner than by the red-edged region.

As described above, the electronic mirror device of the exemplary embodiment employs an existing camera commonly used for electronic mirror devices and calculates the distance between the subsequent vehicle and the own vehicle and the relative velocity, based on time-series images captured by the camera. It has therefore no need of a specific device for measuring the distance between the two vehicles. Besides, compared to the warning by lighting up the brakelight, the warning with use of the display unit of the electronic mirror is recognized by a limited smaller number of drivers including the driver of the subsequent vehicle. The exemplary embodiment, as described above, provides a device capable of detecting a rapid approach of a subsequent vehicle and giving a warning to the subsequent vehicle.

In the description, as an example, the warning criteria is determined based on the distance between the subsequent vehicle and the own vehicle and relative velocity thereof, but it is not limited to this; the velocity of the own vehicle may be employed as a factor in determining warning criteria, in addition to the distance between the subsequent vehicle and the own vehicle and relative velocity. Taking the velocity of the own vehicle into account enhances reliability of warning against the risk of collision.

Also in the warning state, a scaled-down camera image may be displayed in the area inner than the outer periphery region of display unit 501. This allows the device to continuously work as an electronic mirror device even in giving warning.

Further, control unit 502 may obtain data on running condition of the own vehicle from engine ECU (Electronic Control Unit) and perform the process shown in FIG. 8 during a stopping time of the own vehicle. Performing the process in a stopping time of the own vehicle enhances accuracy of determination on the necessity of warning based on the distance between the two vehicles and the relative velocity.

Although the description introduces an example in which the warning is shown by a red-edged outer periphery region, it is not limited to this; the color may be determined according to a degree of collision risk. For example, the warning color may be changed between green, yellow, and red according to a difference level with respect to the warning criteria.

With this, the driver of the subsequent vehicle or of the own vehicle can be aware of the collision risk more precisely.

Further, the outer periphery region of the display may be lit up at a detection timing of the subsequent vehicle. This allows the driver to know the start of the warning function and to be highly aware of detection of a subsequent vehicle.

Further, the display unit may show a camera image other than the rearview image and inform the driver an event detected from an image other than the rearview image by lighting up the outer periphery region of the display. With this, the driver exactly knows, by the lit-up outer periphery region, an event obtained from the camera image other than the rearview image.

The electronic mirror device can be achieved by dedicated hardware implementation. Alternatively, however, it is possible to store a program to implement the function in a computer-readable recording medium, to read the stored program into computer system, and to execute it.

The electronic mirror device and the computer-readable recording medium of the present disclosure is useful for a warning device that detects a subsequent vehicle rapidly approaching to the own vehicle and gives warning to the subsequent vehicle.

What is claimed is:

1. An electronic mirror device comprising:
a display unit, which is disposed on a mounting position of a rearview mirror in an interior of an own vehicle, for displaying an image of an area behind the own vehicle captured by a camera; and
a control unit for controlling the display unit,
wherein the control unit displays the image captured by the camera on the display unit, and lights up an outer periphery region of the display unit upon detection of an approach of a subsequent vehicle based on the image captured by the camera.

2. The electronic mirror device according to claim 1, wherein the control unit scales down the image of the area behind the own vehicle captured by the camera and displays the scaled down image in an area inner than the outer periphery region.

3. The electronic mirror device according to claim 1, wherein the control unit calculates, based on a plurality of time-series images captured by the camera, a distance between the own vehicle and the subsequent vehicle and relative velocity of the subsequent vehicle with respect to the own vehicle, and if calculation results exceed a predetermined value of relative velocity with respect to the distance between the own vehicle and the subsequent vehicle, the control unit lights up the outer periphery region of the display unit.

4. The electronic mirror device according to claim 3, wherein the control unit calculates the distance based on a vehicle width of the subsequent vehicle in the image of the area behind the own vehicle captured by the camera, and calculates the relative velocity based on changes in the vehicle width of the subsequent vehicle in the plurality of time-series images.

5. The electronic mirror device according to claim 3, wherein the control unit scales down the image of the area behind the own vehicle captured by the camera and displays the scaled-down image in an area inner than the outer periphery region of the display unit.

6. The electronic mirror device according to claim 3, wherein the control unit calculates, during a stopping state of the own vehicle, the distance and the relative velocity based on the plurality of time-series images.

7. A non-transitory computer-readable recording medium recording a program for causing a computer to execute a process of controlling an electronic mirror device, comprising:
detecting a subsequent vehicle from an image of an area behind an own vehicle captured by a camera;
calculating a vehicle width of the subsequent vehicle in the image captured by the camera;
calculating a distance between the own vehicle and the subsequent vehicle based on the vehicle width;
calculating a relative velocity of the subsequent vehicle with respect to the own vehicle based on changes in the vehicle width of the subsequent vehicle between the plurality of time-series images captured by the camera;
determining whether the relative velocity with respect to the distance between the own vehicle and the subsequent vehicle exceeds a predetermined value or not; and
lighting up an outer periphery region of a display unit that displays the image captured by the camera if the relative velocity exceeds the predetermined value.

8. The non-transitory computer-readable recording medium recording the program for causing the computer to execute the process of controlling the electronic mirror device according to claim 7, further comprising:
scaling down the image captured by the camera and displaying the scaled-down image in an area inner than the outer periphery region of the display unit, if the relative velocity exceeds the predetermined value.
